(19) United States
(12) Patent Application Publication
(10) Pub. No.: US 2006/0177472 A1
(43) Pub. Date: Aug. 10, 2006

(54) Insect repellent coating and industrial product using the same

(76) Inventor: Toshikazu Tomioka, Osaka (JP)

Correspondence Address: MCDERMOTT WILL & EMERY LLP, 600 13TH STREET, N.W., WASHINGTON, DC, 20005-3096, US

(21) Appl. No.: 10/549,295

(22) PCT Filed: Mar. 31, 2004
(86) PCT No.: PCT/JP04/04725

§ 371 Date: Sep. 16, 2005

(30) Foreign Application Priority Data
Mar. 31, 2003 (JP) 2003-096776

(51) Int. Cl. A01N 65/00

(52) U.S. Cl. 424/405; 424/725; 424/769

(57) ABSTRACT

A pest repellent paint contains at least one extract selected from the group consisting of an extract of a whole plant which belongs to a wintergreen family (Pyrolaceae), an extract of a whole plant which belongs to a nasturtium family (Tropaaeolaceae), an extract of branches and leaves of a plant which belongs to a myrtle family (Myrtaceae), and an extract of a whole plant which belongs to a primrose family (Primulaceae); at least one paint resin selected from the group consisting of polyvinyl alcohol, carboxymethylcellulose, epoxy resin, urethane resin, and polyester resin; and a paint solvent.

### TECHNICAL FIELD

The present invention generally relates to a pest repellent paint and an industrial product using the same. More particularly, the present invention relates to a pest repellent paint for preventing nesting of hygiene pests, household pests, disgusting pests and the like which inhabit the living environment. Moreover, the present invention relates to a pest repellent paint which is effective to improve hygienic problems caused by nesting of pests, to improve comfort of the living environment or to prevent degradation of construction materials, to prevent allergies of residents caused by dead pests, and the like. The present invention also relates to an industrial product having a pest repellent paint of the present invention printed or applied thereto.

### BACKGROUND ART

Pests such as cockroaches usually nest in daily use materials such as equipments, furniture and construction materials which are used in the living environment. Such nesting causes reduced hygiene and discomfort. Moreover, pest waste reduces hygiene and reliability of electric circuits. Pest waste may also cause allergies and therefore may lose residents' health. Accordingly, a method for solving such problems has been desired.

Synthetic chemical substances like agricultural chemicals have been commonly used in order to repel pests such as cockroaches. For example, Japanese Laid-Open Patent Publication No. 7-118112 discloses a method for repelling cockroaches by using a paint having a pyrethroid-based insecticide added thereto.

However, the pyrethroid-based insecticide disclosed in Japanese Laid-Open Patent Publication No. 7-118112 is harmful to human bodies as well, and therefore has safety problems. Since consumers are becoming more and more natural products-oriented in recent years, the use of traditionally used materials which are produced in the nature has been demanded.

### DISCLOSURE OF THE INVENTION

It is an object of the present invention to provide a highly safe pest repellent paint which has little effect on human bodies and which is effective against hygiene pests, disgusting pests and the like commonly inhabiting the living environment. It is another object of the present invention to provide an industrial product having such a pest repellent paint printed or applied thereto.

The present invention uses at least one extract (hereinafter, sometimes referred to as “present extract”) selected from the group (hereinafter, sometimes referred to as extract group) consisting of an extract of a whole plant which belongs to the wintergreen family (Pyrolaceae), an extract of a whole plant which belongs to the nasturtium family (Tropaaeolaceae), an extract of branches and leaves of a plant which belongs to the myrtle family (Myrtaceae) and an extract of a whole plant which belongs to the primrose family (Primulaceae).

During development of the present invention, the inventor arrived at the idea of dispersing the present extract in a molten resin and forming the resin. However, the inventor found out that activity of an active ingredient of the present extract was reduced if the temperature was raised to the melting temperature of a general-purpose resin. In other words, the inventor found out that an active ingredient of the present extract had low heat resistance. The inventor then thought of dispersing the present extract in a paint.

On the other hand, the inventor thought that so-called contact repelling of crawling insects such as cockroaches and ants was effective for application to industrial products. More specifically, long-term duration of the repelling effect is not expected when pests are repelled by using vapor or gas, for example, by volatizing a repelling ingredient so that the pests absorb the repelling ingredient via their spiracles. Moreover, such vapor and gas may cause environmental pollution. In order to solve these problems, the inventor thought that contact repelling would facilitate application to industrial products. Therefore, it has been needed to develop a structure which easily contacts feelers and forelegs of insects and a material which is suitable to that structure, by using the above repelling mechanism.

The inventor found out that, when a paint having the present extract dispersed in water, a dispersion medium of a water paint, was applied to a base material to form a paint film, the paint film had a film of the present extract formed at its surface, and this film of the present extract firmly adhered to the base material by a solid matter of a water resin. Many synthetic polymers such as acrylic resin, polyester resin, epoxy resin, urethane resin, silicon resin and fluoroplastic have been developed as a paint binder of a water paint (refer to page 184 of “Suiyo-sei Koubunshi no Saishin Gijyutsu (The Latest Technology of Water Soluble Polymer)” published by CMC Publishing Co., Ltd.). The inventor found out that, among the above resins, the use of polyvinyl alcohol, carboxymethylcellulose, epoxy resin, urethane resin and polyester resin as a highly hydrophilic resin (paint binder) provided excellent repelling capability. On the other hand, excellent repelling capability was not able to be obtained with acrylic resin, silicon resin and fluoroplastic.

After hard study, the inventor succeeded in developing, by using traditionally used materials which are produced in the nature, a highly safe pest repellent paint containing a natural extract, which has little effect on human bodies and is effective against cockroaches and ants which commonly nest in the living environment. The inventor also succeeded in developing an industrial product having such a pest repellent paint printed or applied thereto.

A pest repellent paint according to a first aspect of the present invention contains: at least one extract selected from the group consisting of an extract of a whole plant which belongs to a wintergreen family (Pyrolaceae), an extract of a whole plant which belongs to a nasturtium family (Tropaaeolaceae), an extract of branches and leaves of a plant which belongs to a myrtle family (Myrtaceae), and an extract of a whole plant which belongs to a primrose family (Primulaceae); at least one paint resin selected from the group consisting of polyvinyl alcohol, carboxymethylcellulose, epoxy resin, urethane resin, and polyester resin; and a paint solvent.

Plants which belong to the wintergreen family (Pyrolaceae) include plants which belong to genus Ichiyakuso (Japanese name) (Pyrola), genus Ginryoso (Japanese name) (Monotropastrum), genus Ichige-ichiyakuso (Japanese name) (Moneses), genus Umegasaso (Japanese name) (Chimaphila), genus Shakujyoso (Japanese name) (Monotropa), genus Koichiyakuso (Japanese name) (Orthilia), and the like. Specific examples of the plants of the wintergreen family are round-leaved wintergreen (Japanese name: Chousen Ichiyakuso) (Pyrola rotundifolia), Ichiyakuso (Japanese name) (Pyrola japonica), Benibana Ichiyakuso (Japanese name) (Pyrola incarnata), Jinyo Ichiyakuso (Japanese name) (Pyrola renifolica), single delight (Japanese name: Ichige Ichiyakuso) (Moneses uniflora), Umegasaso (Japanese name) (Chimaphila japonica), Ginryoso (Japanese name) (Monotropastrum humile), pinesap (Japanese name: Shakujyoso) (Monotropa hypopithys), Indian pipe (Japanese name: Akino Ginryoso) (Monotropa uniflora), Indian pipe (Japanese name: Ginryoso Modoki) (Monotropa uniflora), Marubano Ichiyakuso (Japanese name) (Pyrola nephrophylla), Kobano Ichiyakuso (Japanese name) (Pyrola alpina), sidebells wintergreen (Japanese name: Koichiyakuso) (Orthilia secunda), Karafuto Ichiyakuso (Japanese name) (Pyrola faurieana), Ezo Ichiyakuso (Japanese name) (Pyrola minor), and the like. Round-leaved wintergreen (Japanese name: Chousen Ichiyakuso) is a plant of order Tutuji (Japanese name), family wintergreen. “Chousen Ichiyakuso” is named after-“Ichiyakuso (Japanese name)” which is known as an effective Chinese medicine. Chousen Ichiyakuso is also known as a wild herb, Winter green, which is native to America, England, and Caucasia to the eastern Himalayas. Round-leaved wintergreen has been used since ancient times as an ingredient of a Chinese medicine which is effective for contraception, beriberi, hemostasis, antidiarrheal action, antiphlogistic action and anti-inflammation (for example, refer to Japanese Laid-Open Patent Publication No. 11-310534).

Plants which belong to the nasturtium family (Tropaaeolaceae) include nasturtium (Japanese name: Nozenharen) (Tropaeolum majus), anu (Japanese name: Tamanozenharen) (Tropaeolum tuberosum) and the like. Nasturtium is an ingredient of a Chinese medicine which is grown in various parts of China, and has been used for conjunctivitis. One known way to prescribe it is to crush a fresh plant of nasturtium for external application.

Plants which belong to the myrtle family include plants which belong to genus Yukari (Japanese name) (Eucalyptus), genus Futomomo (Japanese name) (Syzygium), genus Feijyoa, genus Karisutemon (Japanese name) (Callistemon), genus Kameraukiumu (Japanese name) (Chumelaucium), genus Nezumodoki (Japanese name) (Leptospermum), genus Munin-futomomo (Japanese name) (Meterosideros), genus Banjiro (Japanese name) (Psidium), genus Burashinoki (Japanese name) (Callistemon), genus Kayupute (Japanese name) (Melaleuca), genus Tenninka (Japanese name) (Rhodomyrtus) and the like. Specific examples of plants which belong to the myrtle family include eucalypt (Japanese name: Yukarinoki) (Eucalyptus globulus), mountain ash (Eucalyptus regnans), yellow gum (Japanese name: Yanagi-yukari) (Eucalyptus leucoxylon), red ironbark (Japanese name: Aka-gomunoki) (Eucalyptus sideroxylon), Karri (Japanese name: Karii) (Eucalyptus diversicolor), rose apple (Japanese name: Futomomo) (Syzygium jambos), Himefutomomo (Japanese name) (Syzygium chleyeraefolium), clove (Japanese name: Choji) (Syzygium aromaticum), Adeku (Japanese name) (Syzygium buxifolius), Muninfutomomo (Japanese name) (Meterosideros boninenisis), Banjro (Japanese name) (Psidium guajava), guava (Psidium guajava), bottlebrush (Japanese name: Burashinoki) (Callistemon speciosus), Nezumodoki (Japanese name) (Leptospermum ambiguum), cajeput (Japanese name: Kayupute) (Melaleuca leucadendron), Tenninka (Japanese name) (Rhodomyrtus tomentosa), feijoa (Feijoa sellowiana), and the like. Regarding eucalypt, plants which grow in China have been mainly used. Eucalypt has been used for neuralgia as an external medicine and for bronchitis treatment by vapor inhalation.

Plants which belong to the primrose family include plants which belong to genus Okatoranoo (Japanese name) (Lysimachia), genus Sakuraso (Japanese name) (Primula), genus Sikuramen (Japanese name) (Cyclamen), genus Umimidori (Japanese name) (Glaux), genus Tsumatoriso (Japanese name) (Trientalis), genus Tochinaiso (Japanese name) (Androsace), genus Sakurasomodoki (Japanese name) (Cortusa), genus Haihamabossu (Japanese name) (Samolus), genus Hozakizakura (Japanese name) (Stimpsonia), genus Rurihakobe (Anagallis), and the like. Specific examples of plants which belong to the primrose family include Morokosiso (Japanese name) (Lysimachia sikokiana), gooseneck loosestrife (Japanese name: Okatoranoo) (Lysimachia clethroides), Sakuraso (Japanese name) (Primula sieboldii), Hinazakura (Japanese name) (Primula nipponica), Sikuramen (Japanese name) (Cyclamen persicum), Tsutaba-sikuramen (Japanese name) (Cyclamen repandum), sea milkwort (Japanese name: Umimidori) (Glaux maritima), Siomatsuba (Japanese name) (Glaux maritima), chickweed wintergreen (Japanese name: Tsumatoriso) (Trientalis europaea), Tochinaiso (Japanese name) (Androsace chamaejasme subsp. lehamanniana), cortusa (Japanese name: Sakurasomodoki) (Cortusa matthioli), Haihamabossu (Japanese name) (Samolus parviflorus), Hozakizakura (Japanese name) (Stimpsonia chamaedryoides), scarlet pimpernel (Japanese name: Rurihakobe) (Anagallis arvensis), and the like. Morokosiso is a perennial herb which grows in various parts of Okinawa, Japan. Morokosiso is used as a citrus-scented fragrance by, e.g., hanging a dried plant of Morokosiso by the window.

These plants are preferably used after being sufficiently dried in the sun or in the shade. However, these plants may be used in a form with a relatively high water content.

A solvent which is used for extraction is a solvent which includes at least one kind of organic solvent. For example, a solvent for extraction may be one kind of organic solvent, a mixed organic solvent of a plurality of kinds of organic solvents, or a mixed solvent of water and an organic solvent. Examples of an organic solvent include ethyl alcohol, methyl alcohol, acetone, chloroform, benzene, methylene chloride, and the like. One kind of organic solvent or a plurality of kinds of organic solvents selected from the above organic solvents are preferably used. Examples of a mixed solvent of water and an organic solvent include a mixed solvent of water and acetone and a mixed solvent of water and ethyl alcohol. The mixing weight ratio of water to an organic solvent is 5 to 95 parts by weight of water to 95 to 5 parts by weight of an organic solvent, preferably 15 to 85 parts by weight of water to 85 to 15 parts by weight of an organic solvent, and more preferably, 25 to 75 parts by weight of water to 75 to 25 parts by weight of an organic solvent.

Extraction can be conducted by a commonly used method. For example, extraction may be conducted by immersing an extraction part of an ingredient plant in an extraction solvent over an extended period of time. Alternatively, extraction may be conducted by heating and stirring a mixture of an ingredient plant and an extraction solvent at a temperature equal to or lower than the boiling point of the extraction solvent and then filtering the mixture to obtain an extract. It is desirable to prepare an extract by concentrating an extraction solution by an evaporator or a spray dry method.

Preferably, the pest repellent paint according to the first aspect of the present invention is a water paint such as a water-soluble resin paint and a synthetic resin emulsion paint. The water-soluble resin paint is a paint which uses as a paint resin (hereinafter, sometimes referred to as “paint binder”) a water-soluble resin forming a water-soluble colloid (e.g., carboxymethylcellulose and polyvinyl alcohol). The synthetic resin emulsion paint is a paint prepared by dispersing as a paint binder a synthetic resin emulsion resulting from emulsion polymerization or the like in water. Commonly used synthetic resins are acrylic resin, polyester resin, epoxy resin, urethane resin, silicon resin, fluoroplastic, phenol resin, alkyd resin, aminoalkyd resin, urea resin, unsaturated resin, vinyl resin, and the like. In the present invention, a highly hydrophilic resin is used as a paint resin. More specifically, at least one paint resin selected from the group consisting of polyvinyl alcohol, carboxymethylcellulose, epoxy resin, urethane resin and polyester resin is used.

Preferably, the paint contains 1 to 30 parts by weight of the paint resin to 70 to 99 parts by weight of a present extract, and more preferably, 1 to 20 parts by weight of the paint resin to 80 to 99 parts by weight of a present extract, based on a solid content.

Preferably, the paint solvent is at least one solvent selected from the group consisting of water, methyl alcohol, ethyl alcohol, isopropyl alcohol and acetone.

The pest repellent paint of the present invention can be prepared by mixing a dispersion having at least one extract selected from the extract group dispersed therein and a paint containing a paint resin and a paint solvent. Alternatively, the pest repellent paint of the present invention may be prepared by dispersing at least one extract selected from the extract group in a paint containing a paint resin and a paint solvent.

A solvent for dispersing the extract therein is selected based on solubility of the extract and compatibility with the paint resin. Specifically, one kind of solvent or a mixed solvent (a mixture of a plurality of kinds of solvent) selected from the group consisting of water, methyl alcohol, ethyl alcohol, isopropyl alcohol and acetone can be preferably used as a solvent for dispersing the extract therein.

The solvent for dispersing the extract therein and the solvent contained in the paint are typically of the same kind, but may be of different kinds. For example, the solvent for dispersing the extract therein may be water, and the solvent contained in the paint may be a mixed solvent of water and ethyl alcohol.

A pest repellent paint according to a second aspect of the present invention contains: pest repellent particles in which at least one extract selected from the extract group is held by an inorganic carrier; at least one paint resin selected from the group consisting of polyvinyl alcohol, carboxymethylcellulose, epoxy resin, urethane resin and polyester resin; and a paint solvent. This pest repellent paint may be a synthetic resin emulsion paint.

The pest repellent paint according to the second aspect of the present invention may be a paint for causing the pest repellent particles to adhere to a base material by applying the paint to the base material.

In the pest repellent paint of the second aspect of the present invention, the inorganic carrier is preferably formed mainly from a porous inorganic oxide such as silica gel. The inorganic carrier may be particulate powder having a specific surface area of at least 300 m²/g, and preferably at least 500 m²/g, having a silanol group at a surface, and having a grain size of at most 50 μm, and preferably a grain size of 1 μm to 30 μm.

Note that the specific surface area can be measured according to a Brunauer-Emmett-Teller (BET) method described in “The journal of the American Chemical Society”, Vol. 60, page 309, February 1938 and a BET method based on measurement of gas adsorption. The grain size of the particulate powder can be measured by an optical microscope, a scanning electron microscope or a sedimentation method.

The inorganic carrier may be particulate powder formed from an intercalation compound. Examples of the intercalation compound include hydrotalcite compounds and smectite compounds. Hydrotalcite compounds are shown by general formula: [M^{2+1-x}M^{3+x}(OH)₂]^{x+}[A^{n-x/n}.yH₂O]^{x-}.

(where M²⁺ indicates bivalent metal ions such as magnesium, nickel, cobalt, manganese and zinc, M³⁺ indicates trivalent metal ions such as aluminum, iron, manganese and chromium, and Aⁿ⁻ indicates n-valent anions such as hydroxyl group, chlorine, nitrate group, carbonate group and sulfate group.)

Hydrotalcite compounds include trigonal carbonate minerals shown by general formula: A₆B₂(CO₃)(OH)₁₆.4H₂O (where A=Mg, Ni; B=Al, Cr³⁺, Fe³⁺, Mn²⁺, Co³⁺). An example of such carbonate minerals is hydrotalcite shown by Mg₆Al₂(CO₃)(OH)₁₆.4H₂O. Other examples of such carbonate minerals are comblainite, desautelsite, iowaite, pyroaurite, reevesite, stichtite, takovite and the like.

Smectite compounds are monoclinic silicate minerals shown by general formula: X_{0.3}Y₂₋₃Z₄O₁₀(OH)₂.nH₂O (where X (exchangeable ion)=Ca/2, Li, Na; Y=Al, Cr³⁺, Cu²⁺, Fe²⁺, Fe³⁺, Li, Mg, Ni, Zn; and Z=Al, Si). An example of such silicate minerals is montmorillonite shown by (Na, Ca)_{0.3}(Al, Mg)2Si₄O₁₀(OH)₂.nH₂O. Other examples of such silicate minerals are aliettite, beidellite, hectorite, nontronite, saponite, sauconite, stevensite, swinefordite, volkonskoite, yakhontovite, and the like.

Preferably, the grain size of the inorganic carrier is larger than a thickness of a dried paint film of the paint. More specifically, the grain size of the inorganic carrier is preferably in the range of 1 μm to 2,000 μm, and more preferably in the range of 10 μm to 1,000 μm.

Preferably, a solid matter of the paint resulting from applying the pest repellent paint of the second aspect of the present invention (i.e., a paint film formed by applying the pest repellent paint) contains 1 to 30 parts by weight of a resin solid matter of a paint binder (paint resin), 10 to 50 parts by weight of an inorganic carrier, and 49 to 89 parts by weight of a present extract.

Preferably, the solvent contained in the paint is at least one kind of solvent selected from the group consisting of water, methyl alcohol, ethyl alcohol, isopropyl alcohol and acetone.

The pest repellent paint according to the first and second aspects of the present invention may further contain a surfactant. Examples of the surfactant include an anionic surfactant, a cationic surfactant, a nonionic surfactant and an amphoteric surfactant. Preferably, the surfactant is a nonionic surfactant. Examples of the nonionic surfactant include a fatty-acid-based nonionic surfactant, a higher-alcohol-based nonionic surfactant, and an alkylphenol-based nonionic surfactant. Examples of these nonionic surfactants include sucrose fatty acid ester, glycerin fatty acid ester, sorbitan fatty acid ester, polyoxyethylene sorbitan fatty acid ester, polyoxyethylene fatty acid ester, fatty acid alkanolamide, polyoxyethylene alkyl ether, alkylglucoside, polyoxyethylene alkyl phenyl ether, alkylamine oxide, and the like.

Preferably, the ratio of the surfactant to the present extract in the paint is 1 to 500 parts by weight to 100 parts by weight.

An industrial product according to a first aspect of the present invention includes a sheet having the pest repellent paint of the first or second aspect of the present invention printed or applied to a surface. The pest repellent paint can be printed or applied with various patterns to the sheet surface. For example, the pest repellent paint can be printed or applied with a dot pattern, a stripe pattern, a matrix pattern or the like. The surface area of the printed or applied pest repellent paint is at least 50%, and preferably at least 90%, of the sheet surface area. Examples of a method for printing or applying the pest repellent paint include spray painting, screen printing, a roll coater method, gravure, letterpress printing, a dip brazing method, and the like.

Typically, the sheet is made of paper, cloth, metal or synthetic resin, and has a single-layer or multi-layer structure. The sheet is provided at a prescribed position of the industrial product. For example, in the case where the industrial product is a sink cabinet or a washstand, a guide for mounting the sheet thereto is provided in a riser, and the sheet is mounted to the guide. Alternatively, a guide along the floor may be provided under the riser (near the floor) and the sheet may be mounted to the guide.

An industrial product according to a second aspect of the present invention includes a circuit board having the pest repellent paint of the first or second aspect of the present invention printed or applied to one or both surfaces. The pest repellent paint can be printed or applied with various patterns to one or both surfaces of the circuit board. For example, the pest repellent paint can be printed or applied with a dot pattern, a stripe pattern, a matrix pattern, or other specific patterns. The surface area of the printed or applied pest repellent paint is at least 50%, and preferably at least 90%, of the sheet surface area. The pest repellent paint can be printed or applied before or after the circuit board is mounted in the industrial product.

The circuit board is typically a printed circuit board. The industrial product is typically an electric equipment. Examples of the electric equipment include electrical cooking appliances, home electrical appliances, security equipments, communication equipments, office equipments, toiletry equipments, and the like. Specific examples of the electrical equipment include a refrigerator, a wine cellar, a freezer, a microwave oven, an electric thermo pot, a mixer, a juicer, a food processor, a hot plate, an electric grill pot, a fish roaster, a cooking heater, a mochi/dough maker, a water cooler/heater, an electrical water heater, an alkaline ionized water apparatus, a rice cooker, a coffee maker, a coffee mill, a home bread maker, a water purifier, a mineral water apparatus, a system kitchen, a dish washer, a dish drier, a garbage disposer, a clothes washer, a clothes dryer, a vacuum cleaner, an ionized rinse water maker, a futon drier, a polisher, a bath buzzer, an electric bucket-type washer, a shredder, a dehumidifier, a dehumidifying drier, an air cleaner, a shower toilet seat, an air conditioner, a kerosene stove, an electric stove, an electric fan, a humidifier, an electric blanket, a hot-water room heater, a kerosene far-infrared heater, an electric air heater, an oil heater, a kerosene fan heater, a kerosene air heater, a radiation heater, a gas water heater, an electric water heater, a ventilating fan, an underfloor drier, a heat pump water heater, a shaver, a hair depilator/remover, a blow drier, an electric toothbrush, a massaging chair, a lighting equipment, a wiring equipment, a security alarm, a flame sensor, a smoke sensor, a pencil sharpener, a desk cleaner, a television, a videocassette recorder, a video camera, an audio equipment, a DVD (Digital Versatile Disc) player, a personal computer, a peripheral equipment for a personal computer, a facsimile, a telephone, a cell phone, and the like.

An industrial product according to a third aspect of the present invention includes a member impregnated or coated with the pest repellent paint of the first or second aspect of the present invention. The member is typically a base material made of paper, metal or synthetic resin. The member may have any shape as long as the shape is suitable for the industrial product to which the member is to be mounted. For example, the member may be in a sheet or tubular form. Industrial products include various members and equipments. Examples of the industrial product include construction materials, home gardening materials, office equipments, interior members, exterior members, vending machines, auto parts, traffic-related equipments, furniture, cooking appliances, medical and welfare facilities, and the like. Examples of the construction materials include wall paper, an underfloor sheet and the like. Examples of the home gardening materials include a multi film, victoria lawn, a greenhouse film, a fruit cover bag, a drawing string, a support column and the like. Examples of the office equipments include a file cabinet, an office supply cabinet, a locker and the like. Examples of the interior members include a cupboard, an underfloor storage, an animal cage, a curtain, a blind and the like. Examples of the exterior members include a waterproof sheet, a fence, a window screen, and the like. Examples of the auto parts include a seat member, a car air conditioner, a vehicle-mounted refrigerator, a vehicle-mounted AV (Audio-Visual) equipment, and the like. Examples of the traffic-related equipments include a road lighting equipment, a road traffic information terminal, a traffic signal control terminal, an ETC (Electronic Toll Collection system) controller, a train controller, a train communication apparatus, and the like. Examples of the furniture include a cupboard, a bed and the like. Examples of the cooking appliances include a rice cooker, a mixer, a refrigerator, a wine cellar, a serving tray, a rice bin, a seasoning dispenser and the like. Examples of the medical and welfare facilities include a nursing bed, bedding, a serving cart and the like.

The pest repellent paint according to the first or second aspect of the present invention may contain another repellent, an efficacy enhancer, an insect repellent, an attractant, a disinfectant, a deodorizer, an ultraviolet (UV)-blocking agent (including a UV absorber and an agent for preventing UV-induced degradation), an antioxidant, a thickener, a stabilizer, a brightener, a pigment, a dye, a filler and the like.

The pest repellent paint containing a plant extract contains a plant extract other than an active repellent ingredient. The active repellent ingredient and a plant extract other than the active repellent ingredient are both likely to become resources for microorganisms. Therefore, decay may proceed. Decay of the present extract not only degrades the active repellent ingredient but also reduces the contact area of the paint film surface with feelers and forelegs of pests because products produced by the decay cover the paint film surface. This results in degraded contact repelling capability of the present extract. Moreover, when decayed enough to completely lose its repelling capability, the present extract will become food for the pests, attracting the pests rather than repelling them.

In order to prevent degradation in contact repelling capability due to the decay of the present extract, the pest repellent paint of the present invention desirably contains a silver-based antibacterial agent and/or a natural antibacterial agent. The silver-based antibacterial agent may contain a carrier holding silver complexes or silver ions. An example of the carrier holding silver complexes is silica gel holding thiosulphato silver complexes (trade name: Amenitop, Matsushita Electric Industrial Co., Ltd.). Examples of the carrier holding silver ions are zeolite holding silver ions, phosphates holding silver ions, and glass holding silver ions. These carriers may have at least one extract of the extract group adsorbed therein.

Catechin, an extract of Japanese horseradish (Japanese name: Wasabi) (Eutrema japonica, cruciferous family (family “Aburana” in Japanese)), an extract of Moso-chiku (Japanese name) (Phyllostachys pubescens, grass family (family “Ine” in Japanese)) or the like can be used as a natural antibacterial agent. Alternatively, a synthetic compound of an active ingredient contained in a natural antibacterial agent may be used. For example, a synthetic compound of allylisothiocyanate contained in the Wasabi extract may be used.

The amount of the silver-based antibacterial agent or the natural antibacterial agent is preferably in the range of 0.1 to 50 parts by weight to 100 parts by weight of a total solid matter.

The pest repellent paint may contain a synthetic antifungal agent in order to obtain antifungal capability. This improves an anti-decomposition property of the pest repellent paint against true fungi.

Pests with sensory nerves such as cockroaches and ants generally have feelers, legs and the like with cuticular-structure surfaces. Such pests therefore have a different skin structure from humans. Pests such as cockroaches and ants can be repelled by placing in nesting areas or access paths of the pests a neurotransmitter agent which provides irritation that is effective only to pests with sensory nerves such as cockroaches and ants. Unlike an olfaction irritating agent, a neurotransmitter agent does not require a vapor pressure of the agent to be increased. This suppresses excess volatile transpiration of the agent used, thereby enabling the effect of the agent to last over an extended period of time. Moreover, it can be expected that, because of their learning effect, pests such as cockroaches and ants will not make their nests any more after they experience the repelling effect several times.

The pest repellent paint of the present invention contains at least one extract of the extract group as a neurotransmitter agent. The pest repellent paint of the present invention therefore has pest repelling capability against pests with sensory nerves such as cockroaches and ants, and can be used as a pest repellent paint for cockroaches or ants.

Cockroaches include pests of family Gokiburi (Japanese name) (Periplaneta), family Chabanegokiburi (Japanese name) (Blattella) and family Oogokiburi (Japanese name) (Panesthia) which belong to order Mousi (Japanese name) (order Gokiburi (Japanese name)) (Blattaria). For example, cockroaches include German cockroach (Japanese name: Chabanegokiburi) (Blattella germanica), Kyotogokiburi (Japanese name) (Asiablatta kyotensis), Morichabanegokiburi (Japanese name) (Blattella nipponica), smokybrown cockroach (Japanese name: Kurogokiburi) (Periplaneta fuliginosa), Yamatogokiburi (Japanese name) (Periplaneta japonica), brown cockroach (Japanese name: Tobiirogokiburi) (Periplaneta brunnea), Australian cockroach (Japanese name: Kowamongokiburi) (Periplaneta australasiae), American cockroach (Japanese name: Wamongokiburi) (Periplaneta americana), and all other cockroaches.

Ants includes Kuroyamaari (Japanese name) (Formica japonica), Yamatoashinagaari (Japanese name) (Aphaenogaster japonica), Amimeari (Japanese name) (Pristomyrmex pungens), Tobiirokeari (Japanese name) (Lasius japonicus), Ruriari (Japanese name) (Ochetellus itoi), Kuro-ooari (Japanese name) (Camponotus japonicus), Pharaoh ant (Japanese name: lehimeari) (Monomorium pharaonis), Tobiiroshiwaari (Japanese name) (Tetramorium tsushimae), Oozuari (Japanese name) (Pheidole noda), Ameiroari (Japanese name) (Paratrechina flavipes), Mikado-ooari (Japanese name) (Camponotus kiusiuensis), and all other ants.

### BRIEF DESCRIPTION OF THE DRAWINGS

FIG. 1 is a graph showing the evaluation result of a mixed-solvent extract of round-leaved wintergreen;

FIG. 2 is a graph showing the evaluation result of a water extract of round-leaved wintergreen; and

FIG. 3 is a graph showing the evaluation result of a mixed-solvent extract of nasturtium.

### BEST MODE FOR CARRYING OUT THE INVENTION

Hereinafter, embodiments of the present invention will be described. An active ingredient of a pest repellent paint of the present invention is at least one extract selected from the group consisting of an extract of a whole plant which belongs to the wintergreen family (Pyrolaceae), an extract of a whole plant which belongs to the nasturtium family (Tropaaeolaceae), an extract of branches and leaves of a plant which belongs to the myrtle family (Myrtaceae), and an extract of a whole plant which belongs to the primrose family (Primulaceae). By way of example, the embodiments below use an mixed-solvent extract of a whole plant of round-leaved wintergreen of the wintergreen family (Pyrolaceae Pyrola rotundifolia), a mixed-solvent extract of a whole plant of nasturtium of the nasturtium family (Tropaaeolaceae Tropaeolum majus), a mixed-solvent extract of branches and leaves of eucalypt (Myrtaceae Eucalyptus globulus) which is a plant of the myrtle family from China, and a mixed-solvent extract of a whole plant of Morokosiso of the primrose family (Primulaceae Lysimachia sikokiana).

Of the ingredients, round-leaved wintergreen of the wintergreen family and nasturtium of the nasturtium family do not naturally grow in Japan. However, whole plants of round-leaved wintergreen of the wintergreen family and nasturtium of the nasturtium family which grow in, e.g., Yunnan, China, can be used. Round-leaved wintergreen of the wintergreen family is a perennial evergreen herb of 20 cm to 30 cm height whose flowering time is from May to June and fruiting time is from September to October. Round-leaved wintergreen of the wintergreen family grows in damp places like under forest trees and in the shade. This herb is usually grown in Tibet, Yunnan and Guizhou. Whole plants of round-leaved wintergreen of the wintergreen family are dug up by the roots, dirt is removed, and then the whole plants are sun-dried until the leaves get shrunken and soft. The sun-dried plants are piled up for heat generation, and then sun-dried again when both sides of the leaves turn reddish purple or purplish brown. In the embodiments below, this material was used as a whole plant of round-leaved wintergreen.

Whole plants of nasturtium of the nasturtium family are also dug up by the roots, dirt is removed, and then the whole plants are sun-dried. In the embodiments below, this material was used as a whole plant of nasturtium.

Regarding eucalypt of the myrtle family from China, branches and leaves are picked and dried in the shade. In the embodiment below, this material was used as branches and leaves of eucalypt.

Whole plants of Morokosiso of the primrose family are picked by the rootstocks in early summer when round fruits ripen at the leaf axils of the plants, and then steamed and sufficiently dried in the shade. In the embodiments below, this material was used as a whole plant of Morokosiso.

The embodiments below used at least one paint resin selected from the group consisting of polyvinyl alcohol, carboxymethylcellulose, epoxy resin, urethane resin and polyester resin. A so-called water-soluble paint binder was prepared by dispersing a paint resin in water by, e.g., forming emulsion. A pest repellent paint having a present extract dispersed in this water-soluble paint binder will be described in detail.

### First Embodiment

As an example of the present embodiment, a pest repellent paint is prepared using an extract of a whole plant of round-leaved wintergreen of the wintergreen family. A whole plant of round-leaved wintergreen of the wintergreen family was first sufficiently dried in preparation for extraction. The whole plant of round-leaved wintergreen of the wintergreen family was then immersed in a mixed solvent of acetone and water for forty eight hours (the ratio of acetone to water was 70 parts by weight to 30 parts by weight). The resultant solution was concentrated by a rotary evaporator in order to increase the concentration of a substance which was soluble in the mixed solvent of acetone and water. The extract thus obtained is a blackish-brown, highly viscous, sticky substance.

Extraction can be conducted by a commonly used method. For example, extraction may be conducted by immersing an extraction part of an ingredient plant in a mixed solvent over an extended period of time. Alternatively, extraction may be conducted by heating and stirring a mixture of an ingredient plant and a mixed solvent at a temperature equal to or lower than the boiling point of the mixed solvent and then filtering the resultant mixture to obtain an extract. In the present embodiment, an extract having excellent pest repelling capability is obtained by conducting extraction using a mixed solvent of acetone and water.

As described below, the pest repellent paint is obtained by dispersing a present extract in a solvent and mixing the dispersion with a solvent containing a paint resin. A solvent used herein is a solvent which does not affect properties of the paint resin. A suitable solvent is one kind of solvent or a mixed solvent of a plurality of kinds of solvent selected from the group consisting of water, methyl alcohol, ethyl alcohol, isopropyl alcohol and acetone. Warm water of about 40° C. was used in the present embodiment.

The paint resin may be any resin as long as the resin can be used in a common water paint. A urethane-based resin was used in the present embodiment. A urethane-based resin paint was prepared by dispersing a urethane-based resin in water by emulsification (hereinafter, the urethane-based resin is sometimes referred to as water-soluble urethane resin). The water-soluble urethane paint thus prepared was diluted by a paint solvent (water) to an easy-to-paint viscosity.

In the present embodiment, 0.5 to 40 parts by weight of a water-soluble urethane resin and 60 to 99.5 parts by weight of a present extract were mixed and dispersed, based on a solid content. The paint is applied to a film surface, and repelling capability of the paint film was evaluated. Below are shown the evaluation test method and the measurement result of the repelling capability of the present extract.

Evaluation test method:

1. A surface of a polyethylene terephthalate (PET) film was coated with the above paint. The PET film was 10 cm square (100 cm²) and 125 μm thick. The coating amount was 100 mg/100 cm² based on the dry weight of a present extract. Coating may be conducted by a known method such as spray coating and screen printing. A roll coater method was used in the present embodiment. The coated PET film was sufficiently dried in a dust-free place with good ventilation. The coated PET film is hereinafter sometimes referred to as a “present extract”.

A water-soluble urethane paint which does not include the present extract was also prepared by the same method as described above. A PET film coated with this paint in the same manner as described above is hereinafter sometimes referred to as a “blank”.

Each of the samples was weighed before and after the coating process in order to calculate the net weight of the paint material.

2. Two “present extracts” and two “blanks” were respectively placed near the four corners of the bottom (one meter square) of a plastic experimental bath so that the two present extracts and the two blanks faced each other. A shelter serving as a house for cockroaches and a piece of gauze dampen with water were placed near the center of the bottom of the bath. A cube sugar was placed near the center of each sample of the two sample pairs (four samples). Note that the initial weight of each cube sugar was measured in advance.

3. A hundred adult German cockroaches, fifty males and fifty females, were placed in the experimental bath with its atmosphere temperature maintained at 27° C. After seventy two hours, i.e., on the fourth day after the experiment was started, each cube sugar was weighed in order to calculate the intake amount of cube sugar (the consumption amount of cube sugar).

4. The repelling rate was calculated by the following formula:
The repelling rate (%)=(1−(the average consumption amount of cube sugar on the “present extract”)/(the average consumption amount of cube sugar on the “blank”)×100.

Table 1 shows the repelling rate and paint film characteristics for various mixing ratios of the paint resin and the present extract.

TABLE 1

| Resin mixing ratio | Repelling | Paint film |
|---|---|---|
| (based on solid content) | rate | Characteristics |
| 0.005 | ⊚ | No adhesion to base material |
| 0.01 | ⊚ | Soft paint film |
| 0.1 | ⊚ | Excellent paint film |
| 0.2 | ⊚ | Excellent paint film |
| 0.3 | ◯ | Firm paint film |
| 0.4 | Δ | Firm paint film |

In Table 1, the “resin mixing ratio” indicates the ratio of a solid matter of the resin in the solid weight of the pest repellent paint. “⊚” indicates that the repelling rate is 90% or more, “◯” indicates that the repelling rate is 80% or more and less than 90%, and “Δ” indicates that the repelling rate is 60% or more and less than 80%.

The above result confirmed that the pest repellent paint containing 70 to 99 parts by weight of the present extract and 1 to 30 parts by weight of the water-soluble urethane resin had practical coating capability and practical repelling capability.

Below is shown the measurement result of the repelling capability of the present extract with respect to the coating concentration. This evaluation test used a pest repellent paint prepared by mixing and dispersing 5 parts by weight of the water-soluble urethane resin and 95 parts by weight of the present extract, based on a solid content.

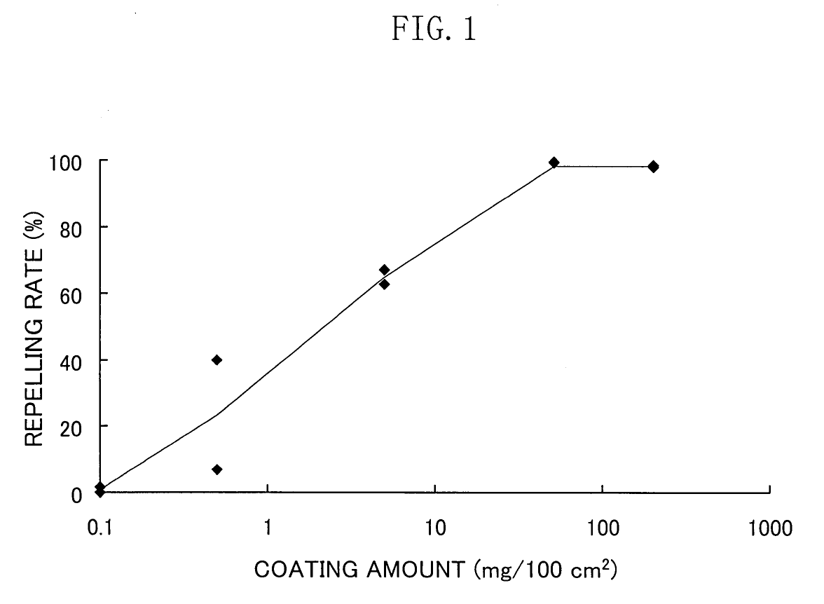

In the graph of FIG. 1, the abscissa indicates the net weight of the present extract and the ordinate indicates the repelling rate of the evaluation result. As shown in FIG. 1, with the coating amount of 100 mg/100 cm² or more, the present extract shows pest repelling capability against German cockroaches which are commonly present in the living environment. The pest repelling capability is at a practical level or higher. Since no dead body of German cockroach was found after the pest repelling test it was confirmed that the present extract was highly safe.

In the above example of the present embodiment, water was used as a solvent for dispersing an extract. However, one kind of solvent or a mixed solvent of a plurality of kinds of solvent selected from the group consisting of water, methyl alcohol, ethyl alcohol, isopropyl alcohol and acetone can be preferably used as a solvent for dispersing an extract. For example, excellent dispersion and excellent repelling capability were confirmed even when a mixed solvent of 30 parts by weight of water and 70 parts by weight of ethyl alcohol was used as a solvent for dispersing an extract.

The same effects were obtained even when polyvinyl alcohol, carboxymethylcellulose, epoxy resin or polyester resin was used as a paint resin instead of urethane-based resin.

Pest repelling capability against insects of other cockroaches such as smokybrown cockroach was evaluated for samples having the above optimal concentration. The evaluation result proved that, like German cockroach, the samples had practical repelling capability against insects of other cockroaches.

### COMPARATIVE EXAMPLE 1

A pest repellent paint was prepared in the same manner as the first embodiment except that water-soluble urethane resin was replaced with acrylic resin. Like the first embodiment, a film surface was coated with a paint, and each paint which formed an excellent paint film was evaluated for repelling capability. The result showed that the repelling rate was less than 60% at any resin mixing ratio and no practical repelling capability was obtained.

### COMPARATIVE EXAMPLE 2

In order to compare the extraction method described in the first embodiment with a water extraction method which is commonly used as an extraction method, cockroach repelling capability was compared between the respective extracts obtained by the two extraction methods. The evaluation result will be described below. A water extract of a whole plant of round-leaved wintergreen of the wintergreen family was obtained by extracting the plant shown in the first embodiment by a water extraction method. Pest repelling capability of this water extract was evaluated by the evaluation method shown in the first embodiment.

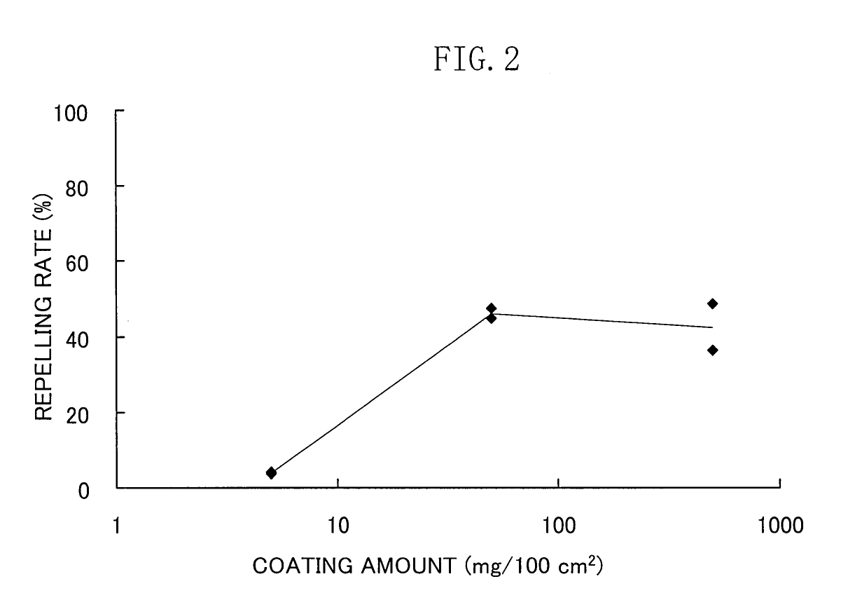

In the graph of FIG. 2, the abscissa indicates the net weight of the water extract and the ordinate indicates the repelling rate of the evaluation result. As shown in FIG. 2, it was confirmed that the water extract had repelling capability but the repelling capability was poor. For example, it was confirmed that the water extract did not show pest repelling capability against German cockroaches which are commonly present in the living environment, even when the coating amount was 100 mg/100 cm² or more which was found effective in the first embodiment.

It can be considered from the results of FIGS. 1 and 2 that only a very small amount of active ingredient was eluted in water extraction, while a large amount of active ingredient was eluted in a mixed solvent of water and an organic solvent. This suggests that different extraction methods have different extraction rates of an active repelling ingredient.

### Second Embodiment

As an example of the present embodiment, a pest repellent paint is prepared using an extract of a whole plant of nasturtium of the nasturtium family. A whole plant of nasturtium of the nasturtium family was first sufficiently dried in preparation for extraction. The whole plant of nasturtium of the nasturtium family was then immersed in a mixed solvent of acetone and water for forty eight hours (the ratio of acetone to water was 70 parts by weight to 30 parts by weight). The resultant solution was concentrated by a spray dry method in order to increase the concentration of a substance which was soluble in the mixed solvent of acetone and water. The extract thus obtained is a deep-brown, highly viscous, sticky substance.

Extraction can be conducted by a commonly used method. For example, extraction may be conducted by immersing an extraction part of an ingredient plant in a mixed solvent over an extended period of time. Alternatively, extraction may be conducted by heating and stirring a mixture of an ingredient plant and a mixed solvent at a temperature equal to or lower than the boiling point of the mixed solvent and then filtering the resultant mixture to obtain an extract. In the present embodiment, an extract having excellent pest repelling capability is obtained by conducting extraction using a mixed solvent of acetone and water.

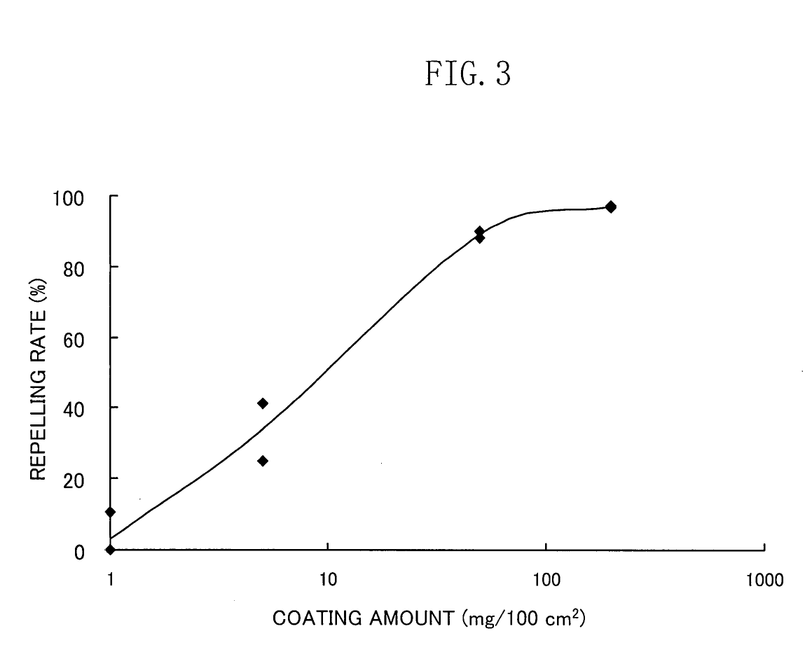

A pest repellent paint was prepared by the same method as the first embodiment, and repelling capability was measured with respect to the coating concentration of the present extract. The result is shown in FIG. 3.

In the graph of FIG. 3, the abscissa indicates the net weight of the present extract and the ordinate indicates the repelling rate of the evaluation result. As shown in FIG. 3, with the coating amount of 100 mg/100 cm² or more, the present extract shows pest repelling capability against German cockroaches which are commonly present in the living environment. The pest repelling capability is at a practical level or higher. Since no dead body of German cockroach was found after the pest repelling test, safety of the present extract was confirmed.

In the above example of the present embodiment, water was used as a solvent for dispersing an extract. However, one kind of solvent or a mixed solvent of a plurality of kinds of solvent selected from the group consisting of water, methyl alcohol, ethyl alcohol, isopropyl alcohol and acetone can be preferably used as a solvent for dispersing an extract. For example, excellent dispersion and excellent repelling capability were confirmed even when a mixed solvent of 30 parts by weight of water and 70 parts by weight of ethyl alcohol was used as a solvent for dispersing an extract.

The same effects were obtained even when polyvinyl alcohol, carboxymethylcellulose, epoxy resin or polyester resin was used as a paint resin instead of urethane-based resin.

Pest repelling capability against insects of other cockroaches such as smokybrown cockroach was evaluated for samples having the above optimal concentration. The evaluation result proved that, like German cockroach, the samples had practical repelling capability against insects of other cockroaches.

### COMPARATIVE EXAMPLE 3

In order to compare the extraction method described in the second embodiment with a water extraction method which is commonly used as an extraction method, cockroach repelling capability was compared between the respective extracts obtained by these two methods. The evaluation result will be described below. A water extract of a whole plant of nasturtium of the nasturtium family was obtained by extracting the plant shown in the second embodiment by a water extraction method. Pest repelling capability of this water extract was evaluated by the evaluation method shown in the first embodiment.

It was confirmed from the evaluation result that the water extract had little repelling capability. For example, the water extract did not show pest repelling capability against German cockroaches which are commonly present in the living environment, even when the coating amount was 100 mg/100 cm² or more which was found effective in the second embodiment.

It can be considered from this result that almost no active ingredient was eluted in water extraction, while an active ingredient was effectively eluted in a mixed solvent of water and an organic solvent. This suggests that different extraction methods have different extraction rates of an active repelling ingredient.

### Third Embodiment

As an example of the present embodiment, a pest repellent paint is prepared using an extract of branches and leaves of eucalypt of the myrtle family. Branches and leaves of eucalypt of the myrtle family were first sufficiently dried in preparation for extraction. The branches and leaves of eucalypt of the myrtle family were then immersed in a mixed solvent of acetone and water for forty eight hours (the ratio of acetone to water was 70 parts by weight to 30 parts by weight). The resultant solution was concentrated by a spray dry method in order to increase the concentration of a substance which was soluble in the mixed solvent of acetone and water. The extract thus obtained is an ivory powdered material.

A pest repellent paint was prepared by the same method as the first embodiment, and repelling capability was measured with respect to the coating concentration of the present extract. The result shows that, with the coating amount of 100 mg/100 cm² or more, the present extract shows pest repelling capability against German cockroaches which are commonly present in the living environment. The pest repelling capability is at a practical level or higher. Since no dead body of German cockroach was found after the pest repelling test, safety of the present extract was confirmed.

In the above example of the present embodiment, water was used as a solvent for dispersing an extract. However, one kind of solvent or a mixed solvent of a plurality of kinds of solvent selected from the group consisting of water, methyl alcohol, ethyl alcohol, isopropyl alcohol and acetone can be preferably used as a solvent for dispersing an extract. For example, excellent dispersion and excellent repelling capability were confirmed even when a mixed solvent of 30 parts by weight of water and 70 parts by weight of ethyl alcohol was used as a solvent for dispersing an extract.

The same effects were obtained even when polyvinyl alcohol, carboxymethylcellulose, epoxy resin or polyester resin was used as a paint resin instead of urethane-based resin.

Pest repelling capability against insects of other cockroaches such as smokybrown cockroach was evaluated for samples having the above optimal concentration. The evaluation result proved that, like German cockroach, the samples had practical repelling capability against insects of other cockroaches.

### Fourth Embodiment

As an example of the present embodiment, a pest repellent paint is prepared using an extract of a whole plant of Morokosiso of the primrose family. A whole plant of Morokosiso of the primrose family was first sufficiently dried in preparation for extraction. The whole plant of Morokosiso of the primrose family was then immersed in a mixed solvent of ethyl alcohol and water for forty eight hours (the ratio of ethyl alcohol to water was 70 parts by weight to 30 parts by weight). The resultant solution was concentrated by a spray dry method in order to increase the concentration of a substance which was soluble in the mixed solvent of ethyl alcohol and water.

A pest repellent paint was prepared by the same method as the first embodiment, and repelling capability was measured with respect to the coating concentration of the present extract. The result shows that, with the coating amount of 100 mg/100 cm² or more, the present extract shows pest repelling capability against German cockroaches which are commonly present in the living environment. The pest repelling capability is at a practical level or higher. Since no dead body of German cockroach was found after the pest repelling test, safety of the present extract was confirmed.

In the above example of the present embodiment, water was used as a solvent for dispersing an extract. However, one kind of solvent or a mixed solvent of a plurality of kinds of solvent selected from the group consisting of water, methyl alcohol, ethyl alcohol, isopropyl alcohol and acetone can be preferably used as a solvent for dispersing an extract. For example, excellent dispersion and excellent repelling capability were confirmed even when a mixed solvent of 30 parts by weight of water and 70 parts by weight of ethyl alcohol was used as a solvent for dispersing an extract.

The same effects were obtained even when polyvinyl alcohol, carboxymethylcellulose, epoxy resin or polyester resin was used as a paint resin instead of urethane-based resin.

Pest repelling capability against insects of other cockroaches such as smokybrown cockroach was evaluated for samples having the above optimal concentration. The evaluation result proved that, like German cockroach, the samples had practical repelling capability against insects of other cockroaches.

### Fifth Embodiment

A pest repellent paint containing a natural antibacterial agent will be described in the present embodiment. The pest repellent paint of the present embodiment is different from the first embodiment in that the pest repellent paint of the present embodiment contains catechin as a natural antibacterial agent. More specifically, the pest repellent paint of the present embodiment is a water paint containing 94 parts of an extract of a whole plant of round-leaved wintergreen of the wintergreen family which was obtained in the same manner as the first embodiment, one part of catechin (made by Mitsui Norin Co., Ltd.) as a tea extract, and 5 parts (based on dry solid weight) of water-soluble urethane resin. The extract and catechin were dispersed in water, a solvent of the paint. The mixing ratio of water was adjusted so that the paint has such a viscosity that provides the best coating condition. Like the first embodiment, a PET film was coated with the pest repellent paint thus prepared, and repelling capability of the film was evaluated using insects (cockroaches).

The result showed that this paint film had excellent initial coating capability and excellent repelling capability. This paint film was left for half a year in an environment of 37° C. at which microorganisms are likely to multiply. After half a year, coating capability of the paint film was observed. Microbial contamination, i.e., decay, was not recognized as opposed to a pest repellent paint having no antibacterial component added thereto. In other words, microbial contamination of the repelling paint film was prevented.

The reason for this can be considered as follows: a pest repellent paint containing a plant extract contains a plant extract other than an active repellent ingredient. An active repellent ingredient and a plant extract other than the active repellent ingredient are both likely to become resources for microorganisms. Therefore, decay may proceed. Decay of the present extract not only degrades the active repellent ingredient but also reduces the contact area of the paint film surface with feelers and forelegs of pests because products produced by the decay cover the paint film surface. This results in degraded contact repelling capability of the present extract. Moreover, when decayed enough to completely lose its repelling capability, the present extract will become food for the pests, attracting the pests rather than repelling them.

According to the present embodiment, degradation due to decay of the present extract and other plant extracts can be prevented. As a result, repelling capability can be reliably maintained.

The natural antibacterial agent is not limited to catechin. The same effects are obtained by a Wasabi extract and a Moso-chiku extract. It is to be understood that the same effects are obtained even when a synthetic compound of an active ingredient contained in a natural antibacterial agent such as allylisothiocyanate is used instead of a natural antibacterial agent.

The pest repellent paint may contain a synthetic antifungal agent in order to obtain antifungal capability. This improves an anti-decomposition property of the pest repellent paint against true fungi.

### Sixth Embodiment

A pest repellent paint containing a silver-based antibacterial agent will be described in the present embodiment. The pest repellent paint of the present embodiment is different from the first embodiment in that the pest repellent paint of the present embodiment contains a silver-complex based antibacterial agent as a silver-based antibacterial agent. A method for preparing the pest repellent paint of the present embodiment will be described specifically. One part by weight of a silver-complex based antibacterial agent (trade name: Amenitop, Matsushita Electric Industrial Co., Ltd.) (silica gel adsorbing thiosulphato silver complexes and having its surface covered with a tetraethoxysilane hydrolyzate) and one part by weight of an extract of a whole plant of round-leaved wintergreen of the wintergreen family were dispersed in twenty parts by weight of water as a solvent. The dispersion was then dried while stirring. Pest repellent particles, i.e., the silver-complex based antibacterial agent with the present extract adhering to its surface, were thus prepared. Two parts by weight of water paint resin was dispersed in advance in water solvent so that coating capability was obtained. Then, 98 parts by weight of the pest repellent particles were dispersed in this paint binder. The pest repellent paint was thus prepared.

By the same method as the fifth embodiment, a PET film was coated with the pest repellent paint, and repelling capability and anti-microbial-decomposition property were evaluated. As a result, practical repelling capability and practical anti-microbial-decomposition property were confirmed.

### Seventh Embodiment

A concentrated extract of a whole plant of nasturtium of the nasturtium family was obtained by the same method as the second embodiment. The extract thus obtained is a brown, highly viscous, sticky substance.

A hydrotalcite compound was prepared as an inorganic carrier. This compound is a layered compound and can hold the present extract between layers. This layered compound is powder (made by TODA KOGYO CORP.) having a length of 0.3 μm in the transverse direction of the layers (the direction approximately perpendicular to the thickness direction), a thickness of 0.06 μm, and a specific surface area of 14 m²/g. This powder and the present extract were dispersed in a mixed solvent of 70% ethyl alcohol and 30% water. After the powder and the present extract were sufficiently dispersed, the solvent was vaporized while stirring the dispersion. Pest repellent particles having the present extract held by the inorganic carrier were thus obtained. A pest repellent paint was prepared by dispersing the pest repellent particles in a water paint obtained by dissolving polyvinyl alcohol in water.

Repelling capability of this pest repellent paint was evaluated by using the evaluation method described in the first embodiment. Table 2 shows the evaluation result.

TABLE 2

| Present | Inorganic | Resin | | |
|---|---|---|---|---|
| extract | carrier | mixing | | |
| mixing ratio | mixing ratio | ratio | | |
| (based on | (based on | (based on | | |
| solid | solid | solid | Repelling | Paint film |
| content) | content) | content) | rate | characteristics |
| 0.89 | 0.1 | 0.01 | ⊚ | Less adhesion |
| | | | | to base material |
| 0.80 | 0.1 | 0.1 | ⊚ | Excellent adhesion |
| | | | | to base material |
| 0.60 | 0.1 | 0.3 | ⊚ | Excellent adhesion |
| | | | | to base material |
| 0.60 | 0.2 | 0.2 | ⊚ | Excellent adhesion |
| | | | | to base material |
| 0.49 | 0.49 | 0.02 | ⊚ | Soft paint film |
| 0.49 | 0.2 | 0.31 | ⊚ | Pest repellent |
| | | | | particles dropped |
| | | | | off |
| 0.39 | 0.51 | 0.1 | Δ | |

In Table 2, the “resin mixing ratio” indicates the ratio of a solid matter of the resin in the solid weight of the pest repellent paint, the “inorganic carrier mixing ratio” indicates the ratio of the powder in the solid weight of the pest repellent paint, and the “present extract mixing ratio” indicates the ratio shown by one minus the sum of the “resin mixing ratio” and the “inorganic carrier mixing ratio”. “⊚” indicates that the repelling rate is 90% or more, and “Δ” indicates that the repelling rate is 60% or more and less than 80%.

The above result confirmed that a pest repellent paint prepared by mixing 49 to 89 parts by weight of the present extract, 10 to 50 parts by weight of the hydrotalcite compound as an inorganic carrier and 1 to 30 parts by weight of polyvinyl alcohol as a paint resin had practical coating capability and practical repelling capability.

By dispersing pest repellent particles in a paint containing polyvinyl alcohol (paint resin), the pest repellent particles adhere to a PET film (base material) coated with the paint. By having a high-concentration present extract held by a carrier, concentration of the present extract can be distributed non-uniformly over the paint film surface. In other words, the present extract can be dispersed within the paint film. As a result, stronger irritation can be provided to sense organs of insects. This effect is similar to the fact that, even if food has the same salt concentration, saltiness sensed by a human tongue is different depending on whether the food has a uniform salt concentration or not. For example, food having salt particles dispersed therein tastes saltier than food which does not have salt particles dispersed therein. Accordingly, a stronger repelling effect can be obtained.

The same effects were obtained even when carboxymethylcellulose, epoxy resin, urethane resin or polyester resin was used as a resin paint instead of polyvinyl alcohol.

The above embodiments proved that a pest repellent paint having an extract of a whole plant of the wintergreen family (Pyrolaceae) or an extract of a whole plant of the nasturtium family (Tropaaeolaceae) dispersed in a paint solvent containing a paint resin has pest repelling capability against insects of at least cockroaches such as German cockroach and smokybrown cockroach.

The insects used in the experiment did not show any symptom such as death after the experiment for the reasons other than natural duration of life. This indicates that the pest repelling mechanism is different from that of common conventional repellents for repelling pests by feeding. More specifically, it can be considered that pests are repelled by irritating their neurotransmitter systems by making feelers and forelegs in contact with the agent. In other words, pests are repelled by contact repelling. From the movement of the sample insects during the test period, it can also be considered that the insects are less likely to enter the region coated with the present extract due to the learning effect of the insects as well.

### Eighth Embodiment

A concentrated extract of branches and leaves of eucalypt of the myrtle family was obtained by the same method as the third embodiment. The extract thus obtained was an ivory powdered material.

The present extract was dispersed in a mixed solvent of 70% ethyl alcohol and 30% water. An intercalation compound having a grain size of about 30 μm was dispersed in the dispersion as an inorganic carrier. The solvent in the dispersion was then vaporized. As a result, pest repellent particles having the present extract held in the inorganic carrier and on the carrier surface were obtained. A smectite compound was used as the intercalation compound. More specifically, montmorillonite was used herein. The mixing ratio of the present extract and the intercalation compound was one part by weight of the intercalation compound to two parts by weight of the present extract. The temperature was maintained at about 40° C. during the step of vaporizing the dispersion.

The pest repellent particles obtained by the above method were ground to a uniform grain size. A surface of a PET film was coated with a thin layer of a water-dispersed paint containing carboxymethylcellulose. The PET film was 10 cm square (100 cm²) and 125 μm thick. The ground pest repellent paint was sprayed over the uncured paint film in order to form a paint film having the pest repellent particles adhering to the surface of the base material.

Repelling capability of this paint film was evaluated by the same evaluation method as the first embodiment. The result shows that, with the coating amount of 100 mg/100 cm² or more, the present extract shows pest repelling capability against German cockroaches which are commonly present in the living environment. The pest repelling capability is at a practical level or higher, and more specifically, 70% or more. Since no dead body of German cockroach was found after the pest repelling test, safety of the present extract was confirmed.

On the other hand, another paint film was formed by the same paint-film formation method as described in the present embodiment except that the present extract was not used. Repelling capability of this paint film was evaluated by the same evaluation method as the first embodiment, but this paint film did not have repelling capability. This shows that repelling capability of the present embodiment results from the present extract rather than the bumps of the paint film surface.

The same effects were obtained even when an extract of a whole plant of round-leaved wintergreen of the wintergreen family, an extract of a whole plant of nasturtium of the nasturtium family, or an extract of a whole plant of Morokosiso of the primrose family was used instead of the extract of branches and leaves of eucalypt of the myrtle family.

### Ninth Embodiment

A whole plant of Morokosiso of the primrose family was first sufficiently dried in preparation for extraction. The whole plant of Morokosiso of the primrose family was then immersed in a mixed solvent of ethyl alcohol and water for forty eight hours (the ratio of ethyl alcohol to water was 70 parts by weight to 30 parts by weight). The resultant solution was concentrated by a spray dry method in order to increase the concentration of a substance which was soluble in the mixed solvent of ethyl alcohol and water.

The present extract thus obtained was dispersed in a mixed solvent of 70% ethyl alcohol and 30% water. An intercalation compound having a grain size of about 30 μm was dispersed in the dispersion as an inorganic carrier. The solvent in the dispersion was then vaporized. As a result, pest repellent particles having the present extract held in the inorganic carrier and on the carrier surface were obtained. A hydrotalcite compound was used as the intercalation compound. The mixing ratio of the present extract and the intercalation compound was one part by weight of the intercalation compound to two parts by weight of the present extract. The temperature was maintained at about 40° C. in the step of vaporizing the dispersion.

The pest repellent particles obtained by the above method were ground to a uniform grain size of about 30 μm. The ground pest repellent particles were dispersed in a water polyester resin paint obtained by emulsifying polyester resin. A pest repellent paint was thus prepared.

A surface of a PET film was coated with a thin layer of the pest repellent paint so that a resin portion had a thickness of about 5 μm. The PET film was 10 cm square (100 cm²) and 125 μm thick. A paint film was formed by drying and curing the thin layer of the pest repellent paint at about 60° C.

Repelling capability of this paint film was evaluated by the same evaluation method as the first embodiment. The result shows that, with the coating amount of 100 mg/100 cm² or more, the present extract shows pest repelling capability against German cockroaches which are commonly present in the living environment. The pest repelling capability is at a practical level or higher. Since no dead body of German cockroach was found after the pest repelling test, safety of the present extract was confirmed.

In the present embodiment, the grain size of the pest repellent particles is about 30 μm, while the thickness of the dried paint film is about 5 μm. In other words, the grain size of the pest repellent particles is larger than the thickness of the dried paint film. The pest repellent particles holding the present extract therefore project from the paint film surface. This increases a contact area between the present extract and insects crawling on the paint film surface. Accordingly, an active repelling ingredient can be effectively absorbed by the insects.

The same effects were obtained even when polyvinyl alcohol, carboxymethylcellulose, epoxy resin or urethane resin was used as a paint resin instead of polyester resin.

### Tenth Embodiment

A pest repellent paint was prepared by the same method as the seventh embodiment except that particulate powder was used as an inorganic carrier. The particulate powder used in the present embodiment is formed mainly from a porous inorganic oxide, has a specific surface area of 300 m²/g or more, has silanol groups at its surface, and has a grain size of 50 μm or less. The pest repellent paint was prepared as follows: pest repellent particles were first prepared by the same method as the seventh embodiment by using fine silica gel particles treated to have a hydrophobic surface and having a grain size of 1 μm (trade name: Sylophobic 200, Fuji Silysia Chemical Corp.). The pest repellent particles were then dispersed in a water paint prepared by dissolving polyvinyl alcohol in water.

Repelling capability of this pest repellent paint was evaluated by using the evaluation method described in the first embodiment. The result confirmed that, like the pest repellent paint using an intercalation compound such as a hydrotalcite compound as an inorganic carrier, the pest repellent paint prepared by mixing 49 to 89 parts by weigh of a present extract, 10 to 50 parts by weight of the fine silica gel particles and 1 to 30 parts by weight of polyvinyl alcohol also had practical coating capability and practical repelling capability.

The same effects were obtained even when carboxymethylcellulose, epoxy resin, urethane resin or polyester resin was used as a paint resin instead of polyvinyl alcohol.

### Eleventh Embodiment

Pest repellent particles were prepared by the same method as the seventh embodiment except that a surfactant was used to disperse an inorganic carrier (hydrotalcite compound) in a mixed solvent. For 100 parts by weight of a present extract, 1 to 500 parts by weight of the surfactant (10 parts by weight in the present embodiment) can be added to the mixed solvent. In the present embodiment, 50 g of the present extract, 50 g of the inorganic carrier and 5 g of sorbitan tristearate (a nonionic surfactant based on sorbitan fatty acid ester) were dispersed in 1,000 ml of the mixed solvent (70% ethyl alcohol and 30% water).

After the present extract, the inorganic carrier and sorbitan tristearate were sufficiently dispersed, the solvent was vaporized while stirring the dispersion. Pest repellent particles having the present extract held by the inorganic carrier were thus obtained. A pest repellent paint was prepared by dispersing the pest repellent particles in a water paint obtained by dissolving polyvinyl alcohol in water.

Repelling capability of this pest repellent paint was evaluated by using the evaluation method described in the first embodiment.

The result confirmed that, like the seventh embodiment which uses only a present extract and an inorganic carrier (hydrotalcite compound) (i.e., no surfactant is added), the pest repellent paint of the present embodiment had practical coating capability and practical repelling capability. Moreover, the pest repellent paint of the present embodiment achieved improved durability of the effect. The mechanism of improving durability of the effect can be considered as follows: the use of the surfactant along with the present extract improves absorption efficiency of the present extract via insects' skin. Since the present extract can be used efficiently, consumption of the present extract is minimized, resulting in improved durability of the repelling effect.

The same effects were obtained even when carboxymethylcellulose, epoxy resin, urethane resin or polyester resin was used as a paint resin instead of polyvinyl alcohol.

### Twelfth Embodiment

A repellent member was produced by coating a base material with a water-soluble urethane paint containing a present extract and water-soluble urethane resin. More specifically, the water-soluble urethane paint was printed with a dot pattern to a 125 μm-thick polyester film with improved surface adhesion property by corona discharge. As a dot pattern, circles of 1 mm diameter were arranged in a matrix at intervals of 3 mm in the longitudinal and transverse directions.

By using this repellent member, nesting conditions of cockroaches were examined in a sink cabinet having a guide mounted along the floor under a riser (near the floor). More specifically, a sheet (repellent member) was mounted in the guide of the sink cabinet so that the coated surface of the repellent member faced upward and the other surface contacted the floor. The result showed that placing the repellent member was significantly advantageous for the nesting conditions of cockroaches as compared to the case where no repellent member was placed.

This result confirmed that hygiene of sink cabinets is improved by placing the repellent member in a part of an access path of pests.

### Thirteenth Embodiment

An electronic circuit board was coated with a resin paint containing a present extract and epoxy resin. More specifically, electronic components were mounted on an electronic circuit board made from glass-fiber reinforced epoxy resin, and the rear and top surfaces of the electronic circuit board were then coated with a resin paint.

Industrial products such as electric equipments which are placed in a kitchen like a rice cooker; home electric products like television and videocassette recorder which always use standby power; security equipments, communication equipments, office equipments and toiletry equipments were produced by using this electronic circuit board. It was confirmed that these industrial products prevented problems such as malfunction and abnormal heat generation of electric circuitry which were caused by entering and nesting of pests in the industrial products.

It was thus confirmed that, by using the pest repellent paint of the present invention in industrial products in which pests may nest, practically enough repellent capability was obtained and durability of the product quality was improved.

### Fourteenth Embodiment

A pest repellent paint containing a present extract, water-soluble urethane resin and an inorganic oxide carrier was prepared. A repellent member was prepared by impregnating or coating the surface of a base material such as a synthetic resin sleet, a synthetic resin film, or paper with this pest repellent paint. This repellent member was mounted in various kinds of equipment. In this way, industrial products were produced such as construction materials like wall paper and underfloor sheet, home gardening materials, office equipments, interior members, exterior members, vending machines, auto parts, traffic-related equipments, furniture, cooking appliances, and medical and welfare facilities.

Field testing confirmed that these industrial products had excellent repelling capability against Kuroyamaari. These members and equipments may not only be placed in the living space, but also used or placed outdoors like under the eaves. In that case, these members and equipments may be damaged not only by cockroaches such as German cockroach and smokybrown cockroach but also by ants such as Kuroyamaari and Yamatoashinagaari. Since the repelling effect against Kuroyamaari was confirmed, the repelling effect against Yamatoashinagaari can also be expected. Moreover, the repelling effect against disgusting pests other than ants can also be expected.

Field testing was also conducted for repelling capability against cockroaches by home monitors. The result confirmed that there was also a practically large repelling effect against German cockroach and smokybrown cockroach.

It was confirmed that these members and equipments prevented reduction in hygiene caused by entering and nesting of pests, relieved discomforts of consumers, and the like.

It was thus confirmed that, by using the pest repellent paint of the present invention in industrial products in which pest may nest, practically enough repelling capability was obtained and the product quality was maintained and improved.

The above embodiments show that an extract of a whole plant which belongs to the wintergreen family (Pyrolaceae), an extract of a whole plant which belongs to the nasturtium family (Tropaaeolaceae), an extract of branches and leaves of a plant which belongs to the myrtle family (Myrtaceae), and an extract of a whole plant which belongs to the primrose family (Primulaceae) have excellent pest repelling capability against cockroaches and ants which commonly inhabit the living environment. Since these plants have been used as Chinese medicines, safety of the plants has been ensured. In other words, it has been ensured that these plants do not affect the human health even if they are left in the living environment. Moreover, these plants are used in a different way from the way they are used as medicines, that is, Chinese medicines which are used only in critical and emergency situations. In other words, repelling ingredients obtained from these plants are used as a chemical substance whish is placed in the living environment rather than being taken by the pests.

Moreover, suppressing nesting of pests prevents the pests from crawling about. As a result, allergies due to diffused microorganisms or flying dust or molds caused by crawling of the pests can be prevented, for example. Suppressing nesting of the pests thus provides great industrial effects.

Moreover, repelling capability can be maintained or improved by, for example, (1) having a present extract held by a carrier, (2) improving absorption efficiency of a repelling ingredient by insects by using a surfactant, and (3) preventing a repelling ingredient itself from becoming resources for microorganisms and maintaining repelling capability by using an antibacterial agent.

The use of the pest repellent paint of the present invention in various industrial products prevents nesting of pests such as hygiene pests, household pests and disgusting pests which inhabit in the living environment. The present invention is effective to improve hygienic problems caused by nesting of pests, to improve comfort of the living environment or to prevent degradation of construction materials, to prevent allergies of residents caused by dead pests, and the like. The present invention is therefore of a large industrial value.

The present invention provides a highly safe pest repellent paint which has little effect on human bodies and which is effective against hygiene pests, disgusting pests and the like commonly inhabiting the living environment. Moreover, the present invention provides an industrial product having such a pest repellent paint printed or applied thereto. Although the embodiments of the present invention have been described, the technical scope of the present invention is not limited to that described in the above embodiments. It is to be understood by those skilled in the art that the above embodiments are exemplary only, and that various modifications having the components of the above embodiments modified in various ways are possible and such modifications also fall within the technical scope of the present invention.

It should be noted that the contents disclosed in the specification, drawings and claims of Japanese Patent Application No. 2003-96776 filed on Mar. 31, 2003 are incorporated herein by reference in their entirety.

### INDUSTRIAL APPLICABILITY

The pest repellent paint of the present invention can be used in industrial products such as sink cabinets, washstands, electric appliances, construction materials, home gardening materials, office equipments, interior members, exterior members, vending machines, auto parts, traffic-related equipments, furniture, cooking appliances, and medical and welfare facilities.

1. A pest repellent paint containing:
at least one extract selected from the group consisting of an extract of a plant which belongs to a wintergreen family, genus Ichiyakuso (Japanese name), and an extract of a plant which belongs to a nasturtium family, genus Nozenharen (Japanese name); and
a paint solvent.

2-4. (canceled)

5. The pest repellent paint according to claim 17, wherein the pest repellent paint contains 1 to 30 parts by weight of the paint resin to 70 to 99 parts by weight of the at least one extract, based on a solid content.

6. A pest repellent paint containing:
pest repellent particles in which at least one extract selected from the group consisting of an extract of a plant which belongs to a wintergreen family, and an extract of a plant which belongs to a nasturtium family is held by an inorganic carrier;
at least one paint resin selected from the group consisting of polyvinyl alcohol, carboxymethylcellulose, epoxy resin, urethane resin, and polyester resin; and
a paint solvent.

7. (canceled)

8. The pest repellent paint according to claim 6, wherein the inorganic carrier is particulate powder formed mainly from a porous inorganic oxide, having a specific surface area of at least 300 m²/g, having a silanol group at a surface, and having a grain size of at most 50 μm.

9. The pest repellent paint according to claim 6, wherein the inorganic carrier is particulate powder formed from an intercalation compound.

10. The pest repellent paint according to claim 6, wherein a grain size of the inorganic carrier is larger than a thickness of a dried paint film of the pest repellent paint.

11. The pest repellent paint according to claim 6, wherein a solid matter of the paint contains 1 to 30 parts by weight of the paint resin, 10 to 50 parts by weight of the inorganic carrier, and 49 to 89 parts by weight of the at least one extract.

12. The pest repellent paint according to claim 1, wherein the pest repellent paint further contains a surfactant.

13. The pest repellent paint according to claim 12, wherein the surfactant includes a nonionic surfactant.

14-15. (canceled)

16. An industrial product comprising a member impregnated or coated with the pest repellent paint according to claim 1.

17. The pest repellent paint according to claim 1 further containing at least one paint resin selected from the group consisting of polyvinyl alcohol, carboxymethylcellulose, epoxy resin, urethane resin, and polyester resin.

18. The pest repellant paint according to claim 1 further containing a silver-based antibacterial agent and/or a natural antibacterial agent.

19. The pest repellent paint according to claim 18,
wherein the silver-based antibacterial agent contains carrier holding silver complexes or silver icons.

20. The pest repellent paint according to claim 18,
wherein an amount of the silver-based antibacterial agent and/or the natural antibacterial agent is in the range of 0.1 to 50 parts by weight to 100 parts by weight of a total solid matter.

21. The pest repellent paint according to claim 5,
wherein the pest repellent paint contains 1 to 20 parts by weight of the paint resin to 80 to 99 parts by weight of the at least one extract, based on a solid content.

22. The pest repellent paint according to claim 1,
wherein the paint solvent contains at least one kind of solvent selected from the group consisting of water, methyl alcohol, ethyl alcohol, isopropyl alcohol and acetone.
